(19) United States
(12) Patent Application Publication
(10) Pub. No.: US 2012/0094250 A1
(43) Pub. Date: Apr. 19, 2012

(54) GAS TREATMENT METHODS

(76) Inventors: Geoffrey Morgan LLOYD, College Town (GB); Cormac John Devery, Felbridge (GB); Rodney Stewart Mason, Blackpill (GB)

(21) Appl. No.: 13/083,690

(22) Filed: Apr. 11, 2011

(30) Foreign Application Priority Data
Apr. 15, 2010 (GB) 1006327.9

(51) Int. Cl. A61C 19/06

(52) U.S. Cl. 433/80; 433/215; 433/216

(57) ABSTRACT

A method of oral treatment comprises passing a flow of a gas mixture from a pressure vessel containing the gas mixture through a generator of non-thermal plasma; applying a partially ionising electrical potential to the flow of the gas mixture in the plasma generator, and thereby forming a non-thermal gaseous plasma in the gas mixture, and causing the flow of the gas mixture downstream of the plasma generator to perform the oral treatment. The gas mixture comprises (a) a noble gas selected from helium and argon and mixtures thereof, and (b) an additive gas selected from water vapour, air, oxygen, nitrogen, hydrogen, carbon monoxide, carbon dioxide, nitrous oxide and nitric oxide and mixtures of any two or more thereof. The additive gas forms up to 1% by volume of the gas mixture. The oral treatment may be the cosmetic whitening of teeth, the non-clinical cleaning of teeth or the in situ cleaning of orthodontic braces, amongst others.

### BACKGROUND OF THE INVENTION

This invention relates to gas treatment methods, that is methods that employ gas, and the use of gas mixtures in such methods.

There is currently much research interest in the use of non-thermal gaseous plasma in a number of therapeutic and oral care applications. Suggested uses of a non-thermal gaseous plasma include the treatment of wounds, the cosmetic whitening of teeth, both to remove stains and to whiten tooth enamel, and the cleaning of teeth. See, for example, US-A-2009/004620 and EP-A-2 160 081.

The non-thermal plasma is typically formed by striking an electric discharge between electrodes in a cell containing a helium atmosphere. Typically, a flow of helium passes through the cell and is then directed from the cell to a substrate to be treated. The effect of the electric discharge is to ionise some of the helium atoms in the cell. Other helium atoms are excited by the electric discharge. That is to say, in each excited helium atom, an electron is raised to a quantum level above its ground state. Excited and ionised helium atoms are no longer inert and can directly or indirectly mediate, for example, the sterilisation, at least in part, or the cleaning of a substrate or surface.

EP-A-2 160 081 seeks to improve the sterilisation effect of the plasma on, for example, wounds. That object is according to EP-A-2 160 081 achieved by mixing the helium with an additive. A large number of different additives are disclosed. Examples of gaseous additives include neon, argon, krypton, xenon, nitric oxide, oxygen, hydrogen, sulphur hexafluoride, nitrous oxide, hexafluoroethane, methane, carbon fluoride, fluoroform, and carbon dioxide. Water and ethanol are also disclosed as suitable additives. In order to form a mixture of a carrier gas (typically helium) and a gaseous additive, EP-A-2 160 801 discloses the use of separate sources of the carrier gas and the additive, and controlling their supply to a gas mixer which communicates with a plasma generator.

This method is, we believe, not readily adapted to being simply and effectively carried out.

### SUMMARY

According to the present invention there is provided a method of non-clinical or cosmetic oral treatment, comprising passing a flow of a gas mixture from a pressure vessel containing the gas mixture through a generator of non-thermal plasma; applying a partially ionising electrical potential to the flow of the gas mixture in the plasma generator, and thereby forming a non-thermal gaseous plasma in the gas mixture, and causing the flow of the gas mixture downstream of the plasma generator to perform the non-clinical or cosmetic oral treatment, wherein the gas mixture comprises (a) a noble gas selected from helium and argon and mixtures thereof, and (b) an additive gas selected from water vapour, air, oxygen, nitrogen, hydrogen, carbon monoxide, carbon dioxide, nitrous oxide and nitric oxide and mixtures of any two or more thereof, and wherein the additive gas forms up to 1% by volume of the gas mixture.

The noble gas is preferably helium in view of its thermal properties.

The invention is based on a number of different findings in plasma chemistry. When a non-thermal gaseous plasma is used in, for example, oral treatment, it is undesirable to form the plasma in the oral cavity itself. It is therefore formed outside the oral cavity and flows into the oral cavity. The non-thermal plasma may simply be discharged to the atmosphere from the plasma generator, or may travel from the plasma generator in a tube or similar applicator, which tube discharges into the atmosphere. If desired, the discharge end of the tube can be inserted into the oral cavity and pointed at the surface to be treated. Strictly speaking, once the flow of gas mixture leaves the plasma generator, it is no longer a plasma unless an external electrical potential continues to be applied to it. It is simply a gas mixture containing ionic and excited species. The term “plasma” shall be reserved herein for the description of a partially ionised gas or gas mixture to which an electric potential is applied. The plasma typically glows. The flow of the gas mixture along the applicator shall be referred to as an “afterglow”, and the flow of the gas mixture once it has exited the applicator shall be referred to as a “plume”. Our experimental findings are that if the gas supplied to the plasma generator is essentially pure helium, the resulting plume contains very few ions indeed. It is to be understood that the number of ions in the gas mixture is related to the number of other active species, namely free radicals and excited atoms and molecules. Accordingly, it is to be expected that the helium plume will not be a particularly effective oral treatment agent.

On the other hand, if the additive gas is included the gas flowing to the plasma generator, substantially more ions are included in the plume, making it, we believe, an effective oral treatment agent.

There is, we believe, another useful effect of including an additive gas in the gas mixture used in the method according to the invention. If pure helium is used to form the non-thermal gaseous plasma, some additive gas may adventitiously enter the plasma generator through a leaky joint, by back diffusion of atmospheric gas, or by outgassing the materials of the plasma generator. Such effects by their very nature tend to be unpredictable and non-reproducible. If these effects are to be relied upon for an effective oral treatment, it becomes very difficult to optimise the treatment. The effect of deliberately including a controlled amount of an additive gas in the gas mixture is to keep down the effect of adventitious entry of additive gas into the plasma generator, making possible reproducible oral treatment.

We have further found that there is no simple linear relationship between the population of ionic species in the plume and the concentration of additive gas in the gas mixture. On the contrary, the maximum population is reached when the concentration of gas in the mixture is much less than 1% by volume. Under our experimental conditions, we were finding, depending on the choice of the additive gas, that the maximum population of ions was achieved at concentration levels of additive gas of less than 0.5% by volume but more than 0.01% by volume.

The total concentration of additive gas in the gas mixture is preferably therefore in the range of 0.01% by volume to 0.5% by volume, more preferably in the range of 0.02% by volume to 0.25% by volume.

We attribute these results partly to a tendency we have found for the additive gas to quench the non-thermal plasma in the plasma generator. Once the maximum is reached, the plasma-quenching effect reduces the total number of ions present in the plume. Further, in the example of helium as the carrier gas, because it has a particularly high ionisation energy, ions of the additive gas will we believe be formed preferentially in the discharge.

Since only up to 1% by volume of additive gas is employed in the gas mixture, the apparatus shown in EP-A-2 160 081 is unsuitable for its preparation by direct mixing of its essentially pure components. This is because simple gas mixers are not able to produce the gas mixture to reliable accuracy. It is therefore a feature of the present invention that the gas mixture is preformed and provided in a pressure vessel such as a gas cylinder.

The non-clinical or cosmetic oral treatment may comprise:

the removal of stains from teeth;

the whitening of tooth enamel;

the general cleaning of teeth to destroy harmful bacteria;

the interdental cleaning of teeth;

the freshening of breath;

the treatment of halitosis

the treatment of gingivitis;

the treatment of periodontal disease

the in situ cleaning of orthodontic braces

the in situ cleaning of dental implants.

In each of the above examples, the flow of the gas mixture downstream of the plasma generator may be directed at the tooth or teeth to be treated, or the area of gums to be treated, or in the case of breath freshening or treatment of halitosis, at the back of the mouth for a sufficient period of time to have a desired effect.

Normal treatment time periods for a typical treatment are from ten seconds to ten minutes. The treatment may be repeated daily or at shorter or longer intervals.

It will readily be appreciated that the principles of the invention may be applied to clinical oral care treatment.

Accordingly the invention also provides a gas mixture comprising a noble gas selected from helium and argon and mixtures thereof, and an additive gas selected from water vapour, air, oxygen, nitrogen, hydrogen, carbon monoxide, carbon dioxide, nitrous oxide and nitric oxide and mixtures of any two or more thereof, wherein the additive gas forms up to 1% by volume of the gas mixture, the gas mixture being stored in a pressure vessel, and being for use when partially ionised in clinical oral or dental treatment of a patient.

Preferred additive gases are those which readily form hydroxyl radicals or active oxygen atoms or molecules. Air, oxygen and water vapour are thus preferred.

Another additive gas is a mixture of (a) oxygen and/or air with (b) hydrogen. Reactions of such a gas mixture, when partially ionised, lead to the formation of hydroxyl radicals.

A prepackaged gas mixture of (a) helium and/or argon and (b) water vapour, wherein the gas mixture contains up to 1% by volume, more preferably up to 0.2% by volume, of water vapour is believed to be novel.

Accordingly, the invention also provides a gas mixture, pre-packaged in a pressure vessel, comprising (a) at least 99% by volume of helium and/or argon and (b) water vapour, wherein the content of water vapour is up to 1% of the total volume of the gas mixture.

The plasma generator preferably has a gas outlet temperature of from 10° C. to 40° C. Higher gas temperatures are generally unsuitable for oral treatments and may damage the mouth or teeth if sustained for too long a period. Temperatures lower than 10° C. may be found uncomfortable by the person undergoing the treatment and in any event are difficult to achieve without unnecessary cooling of the gas mixture.

The plasma generator is preferably operated at atmospheric pressure or in the range 0.5 bar to 2.0 bar.

The plasma generator preferably comprises a housing, at least one cathode and at least one anode, and a voltage signal generator operatively associated with the cathode and the anode.

The voltage signal generator preferably generates a pulsed DC or an AC or an RF voltage signal suitable for the generation of a non-thermal plasma. It is possible to transform a low DC voltage in the order of 5 to 15V into a suitable AC or pulsed DC voltage to provide a glow discharge in the plasma generator.

The plasma generator, a battery for generating a DC voltage an electrical circuitry for transforming the DC voltage in a non-thermal plasma generating voltage may all be located in the same housing. The housing may have a configuration which enables it to be held and operated in the hand. The housing may also contain or dock with a pressure vessel in the form of a capsule for storing the gas mixture. The capsule may have a (water) capacity of from 10 to 100, preferably 10 to 40 ml, and, when full, a pressure of at least 50 bar, preferably at least 100 bar.

Gas mixtures for use in the methods according to the invention may usefully include nitrous oxide or nitric oxide as the additive gas or a component of it.

The partially ionised gas may flow out of the plasma generator directly to the atmosphere. Alternatively, it may flow from the plasma generator to an applicator. Although it is often convenient to have a tube or other applicator that can readily be pointed at the location to which the partially-ionised gas is to be directed, it is desirable to keep the length of the applicator to a minimum and typically less than 5 cm or 10 cm. This is because ionic and excited species in the partially-ionised gas mixtures tend with time to revert to their non-ionic ground state.

According to another aspect of the present invention, there is provided a method of cleaning in situ an orthodontic brace by directing at the brace a plume of partially-ionised gas. The plume is preferably formed by passing a stream of gas through a plasma generating chamber of a generator of non-thermal plasma and applying a partially-ionising electrical potential to the stream of gas in the generator. The operating pressure and temperature of the plasma generator may be as described above. The gas stream may have a composition as described above. The plasma is believed to kill at least some plaque-precursive bacteria that tend to colonise the brace in the oral cavity.

### BRIEF DESCRIPTION OF THE DRAWINGS

The methods according to the invention will now be described, by way of example, with reference to the accompanying drawings, in which

FIG. 1 is a schematic diagram of an experimental non-thermal gaseous plasma generating apparatus which was used in the mass spectrometry experiments to be described below.

FIG. 2 is a mass spectrum of a plume resulting from the partial ionisation of helium,

FIG. 3 is a mass spectrum of a plume resulting from the partial ionisation of a gas mixture having the composition 99.5% by volume of helium, 0.5% by volume of air;

FIG. 4 is a mass spectrum of a plume resulting from the partial ionisation of a gas mixture having the composition 99.8% by volume of helium, 0.2% by volume of air;

FIG. 5 shows mass spectra of plumes resulting from the partial ionisation of gas mixtures having the compositions 99.9% by volume of helium, 0.1% by volume of nitrogen and 99.9% by volume of helium, 0.1% by volume of oxygen,

FIGS. 6 and 7 show mass spectra of plumes resulting from the partial ionisation of gas mixtures having the compositions 99.99% by volume of helium and 0.01% by volume of water vapour; and

FIGS. 8 and 9 are sets of photographs illustrating the effect on Streptococci mutans bacteria of a plume resulting from the partial ionisation of a gas mixture consisting of 99.95% by volume of helium, 0.05% by volume of water vapour.

### DETAILED DESCRIPTION OF PREFERRED EMBODIMENTS

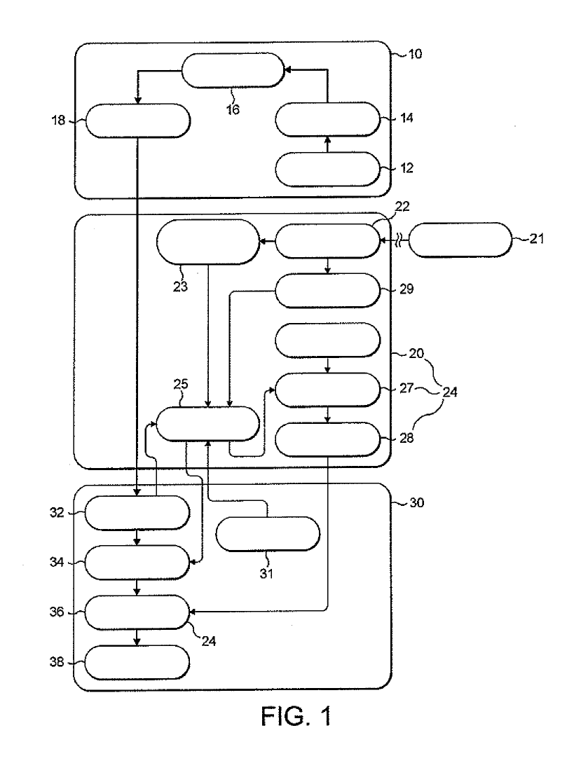

Referring to FIG. 1, apparatus is shown for generating a non thermal plasma which may be in the form of a gas plume emitted from the device. In the embodiment illustrated, the apparatus includes a gas supply 10, a handheld unit (or first housing) 30 and a bench unit 20 (or second housing). The apparatus provides a flow of a modified gaseous species for treatment of a treatment region of a human or animal body. A generator 36 having at least one electrode 44, 46 which can be energised for forming a non-thermal plasma is located in the handheld unit 30. The handheld unit 30 has a configuration which enables it to be held by hand and operated for treating the treatment region. An inlet port 56 is provided in the housing for a flow gas communicating with the generator and an outlet port 58 allows flow of the modified gaseous species from the generator. The bench unit 20 is remote from the first housing, and has located in, for example, a battery compartment one or more batteries and a signal generator for converting voltage generated by the battery when located in the second housing into a pulsed high voltage signal. A gas passage 50 through the second housing is connectable to the inlet port by a hose 52, having a gas conduit 60, and electrical leads 54 for applying the pulsed high voltage signal to the said at least one electrode of the generator.

The gas cylinder 12 is provided as the pressure vessel of the gas supply. This is typically a 1 litre or 1.5 litre cylinder filled with helium and an additive gas, suitable for generating a non-thermal plasma for providing a beneficial or therapeutic effect on a treatment region of a human or animal. In this way, the modified gas stream may, for example, include hydroxyl radicals (OH) which are effective for stain removal from teeth. It will be understood that the cylinder is not limited to the size or content indicated although the upper limit is preferably less than 1.5 litres so that the apparatus is portable by hand. The cylinder may be provided with an integral pressure regulator 14. Located external to the cylinder 12 is a flow controller 16. The flow controller 16 may be set to a value in the range of 0.5 to 5 l/minute. A further pressure regulator 18 is located downstream of the flow controller 16. This pressure regulator 18 releases gas flow at a pressure of 1.5 bar absolute. An outlet port of the gas supply is connected to an inlet port of the bench unit 20 by a hose 64.

The bench unit 20 includes a battery 22 and energising means 24 electrically connected to the battery 22. The battery illustrated is a 12V battery. The battery may be supplied with a battery charger 21 and a display LED 23. The display LED can indicate the status of the battery, i.e. it informs the user when the available power in the battery 22 is low. The bench unit comprises means for locating the battery or batteries in the unit so that they are placed in contact with electrical connections or terminals. The locating means may comprise a battery compartment shaped to receive the required battery or batteries and a removable cover for closing the compartment. The bench unit further comprises a gas passage for conveying gas from the gas supply 10 to the handheld unit 30.

The energising means as described in more detail below comprises one or more signal generators which receive energy from the battery and one or more electrodes driven by the generators for energising a plasma in a reaction chamber. The energising means may include a low voltage signal generator 27 in connection with a high voltage generator 28.

In the illustrated arrangement, the signal generators convert the electrical current from a 12V battery into a pulsed output voltage in the range 4 to 6 kV at a frequency of 2-10 kHz which is suitable for generation of a non-thermal plasma. A transformer can be used to step up the voltage and enable voltage pulses in the desired range of 4 to 6 kV to be generated. In order to produce clear, well defined pulses it is desirable to keep the number of turns and inductance of the windings of the transformer to low levels and to have modest step-up ratios. This approach helps keep the unwanted parasitic elements of leakage inductance and stray winding capacitance to a minimum, both of which contribute to pulse distortion.

Because a pulse transformer has low primary winding inductance, the magnetising current that generates the working magnetic flux in the core is substantial, leading to significant stored magnetic energy in the transformer during the pulse record. For an efficient design, this magnetic energy is recovered at the end of the pulse and temporarily held in another form (usually as a charge on a capacitor) ready to generate the next pulse.

The magnetic flux in the core of the transformer must be returned to zero before the next pulse is generated otherwise the flux builds up with successive pulses until the core saturates, at which point the transformer stops working and acts as a short circuit to the drive electronics.

A common method of magnetic energy recovery in switched-node power supply transformers, which may be used in this case, is through the use of a so-called “flyback” winding. This is usually identical to the primary winding and both wound on the core at the same time (a bipolar winding) in order to ensure a high level of magnetic coupling between the two. The flyback winding connects between ground and the reservoir capacitor of the DC supply via a blocking diode.

During pulse generation a fixed voltage is applied to the primary winding and current ramps up building up magnetic flux in the core this induces an equal and opposite voltage across the flyback winding (but no current flows due to a blocking diode). Interruption of the primary current at the end of the pulse forces the magnetic field to start collapsing which reverses the induced voltage across the flyback winding and causes current to flow back into the supply capacitor. The flux and current ramp down smoothly to zero ready for the next pulse.

Another suitable transformer configuration is a push-pull design in which two identical bifilar wound primary windings are alternately connected to the DC power supply. The phasing of the windings is such that magnetic flux in the core is generated with opposing directions which each is alternately driven.

A push-pull design also allows stored magnetic energy to be recovered and returned to the supply capacitor in a very similar fashion to the flyback approach, where the blocking diode now becomes an active transistor switch. The same transformer design may be used for either approach. Although the push-pull design requires additional switching transistor and control, it allows the possibility of doubling the change in magnetic flux within the limits of the core by using both positive and negative flux excursions. The flyback design outlined above only allows unipolar flux excursions. For a given flux ramp rate, the push-pull design has the capability to produce a continuous pulse with twice the duration of a flyback version using the same transformer.

A control 25, which may be in the form of a logic circuit is configured to receive a plurality of inputs which are dependent on a condition of the apparatus and selectively supply an output to the energising means, for example signal generator 27 in this example, for energising a plasma in the reaction chamber 36. The control is electrically connected to the switch 31, flow sensor 32 and valve 34 by an electrical 68 running through flexible hose 52. The signal generator may be configured to generate a signal for driving the electrodes which may be a low duty cycle signal in which the energy is provided to the or each electrode for less than 15% of the cycle. In the embodiment illustrated in FIG. 1 the power source is a 6 kV AC driver. It is able to generate voltage pulses of one millisecond duration every six milliseconds. If desired, a different pulsing regime may be employed. For example, the pulses may be of shorter duration but may be more frequent. In another preferred embodiment the signal generator may be configured to generate a pulsed DC signal.

The handheld unit 30 is configured by, for example, size and shape and weight such that it can be operated by a user by hand and the resulting plasma easily directed by the user to treat an oral region of a human or animal body. The handheld unit 30 includes a flow sensor 32, a solenoid valve 34, a reaction generator 36 and a nozzle 38. The solenoid valve is located downstream of the flow sensor 32. The reaction generator is located downstream of the solenoid valve 34. The reaction generator is provided with a plurality of electrodes therein. The nozzle 38 is located downstream of the generator 36 and is adapted for directing a plasma plume to a treatment region of a human or animal. Also located within the unit 30 is an on/off switch 31. The nozzle may be coupled to a mass spectrometer (not shown) for the purpose of the Examples set out below.

A method of operating the apparatus will now be described with reference to FIG. 1.

The control 25 is configured to receive inputs from low battery monitor 23, switches 29 and 31, and the flow sensor 32. The control outputs to the signal generator 27 and the solenoid valve 34 when prescribed inputs are received by the control. In this regard, the low battery monitor 23 sends a signal to the control indicating whether or not there is sufficient energy stored in the source 22 for energising plasma in the reaction chamber 26. If the source has insufficient energy the control does not allow operation of the apparatus. If the source 22 has sufficient energy, the apparatus can be activated by operation of desk top switch 29 which outputs a signal to the control 25. The hand unit switch 31 is subsequently operated to supply an output to the control 25. The control receives the output from the switch 31 and if the output is positive and provided the switch 29 has been previously operated, the control sends an output to the solenoid valve 34 causing it to open to allow the flow of gas from pressure regulator 18. The flow sensor 32 sends an output to the control 25 if it senses that the flow of gas into the reaction chamber 36 is above a predetermined mass or volume flow rate. If the control receives a positive output from the sensor 32, the control emits a control signal to the energising means 24 thereby allowing the low voltage signal generator to be energised together with the high voltage generator for activating the electrodes. Accordingly, a plasma can be energised in the reaction chamber only if gas flow through the reaction chamber is above a predetermined rate.

During operation of the device gas flowing from the pressure regulator 18 passes through the flow sensor 32. The gas flow then continues to pass through the solenoid valve 34 to the reaction generator 36. If the flow rate is the required amount, as predetermined, the electrodes in the reaction generator are activated by the signal generator as part of the energising means 24. The gas is thus energised and forms a gas plasma. The plasma exits the generator 36 and passes through the nozzle 38. The nozzle concentrates the flow of plasma. The user directs the nozzle towards the treatment area. The nozzle may be replaceable.

The experimental apparatus employed a plasma generator in the form of a tubular quartz discharge tube of 4 mm internal diameter which is connected to a narrower quartz applicator tube (30 mm in length, and 2.5 mm in internal diameter). A cylindrical outer electrode was made using silver paint on the discharge tube and using metallised epoxy resin. The inner electrode was formed of copper wire strands inserted into a narrow quartz tube, closed at one end, and packed with graphite to make uninterrupted contact between the rod and the inner surface. This was inserted into the discharge tube to make a concentric double dielectric electrode discharge. The quartz wall thickness of the inner electrode was 0.6 mm and the outer electrode 0.9 mm. The gap between the electrodes was approximately 0.4 mm. The discharge region was about 15 mm long. The arrangement was held together by machined parts of PEEK and O-rings were used to seal the various parts to each other.

Gases were supplied through stainless steel pipe and swagelock fittings.

The entire apparatus was mounted on a platform. The platform was aligned with the sample aperture of a mass spectrometer (Hiden, model HPR60 MBMSS) at a fixed distance of 3 mm.

Two experimental arrangements were used. In one gap between the applicator tube and the mass spectrometer was open to the air (“open coupling”); in the other a PEEK spacer was sealed leak-tight between the sample tube of the mass spectrometer and the applicator tube.

The choice of materials described above was made with a view to minimising the effect of outgassing on the gas composition to be subjected to the electric discharge.

In the experiments described below the discharge generating non-thermal gaseous plasma was powered by a high frequency AC (50 kHz) circuit operating at up to 6 kV (peak to peak), which was gated on and off in order to control the average power feed into the discharge. The power supply was driven by a DC supply operating at 12V. The current drain depended linearly on the fraction of time for which the output high frequency was gated on. The maximum DC current was set at less than 1 A. The range of current drawn was between about 0.15 and 0.85 A, depending on the composition of gas in the discharge. At low current consumption (0.15 A), the AC voltage pulses endured for approximately 1 ms (the so-called “mask”) with the gap between voltage pulses being in the range of 10 and 11 ms (the so-called “space”). These were measured from a pick-up on the dangling oscilloscope lead. It was first established that the mask/space ratio was directly proportional to the current drawn from the power source and it was the latter that was then used to register the power input into the discharge, usually at either 0.15 to 0.8 A, although this was not the actual current dissipated across the electrodes and within the discharge.

### Example 1

### Comparative

In this example, the ionic species were counted by the mass spectrometer when the plasma generator was operated with pure helium as the gas subjected to the electric (glow) discharge. In short, no ions in the helium plume were detected by the mass spectrometer. This result indicates that helium ions formed in the plasma generator have a very short half life. The absence of ions occurred when the mass spectrometer had a closed coupling to the plasma generator, and when it had an open coupling thereto.

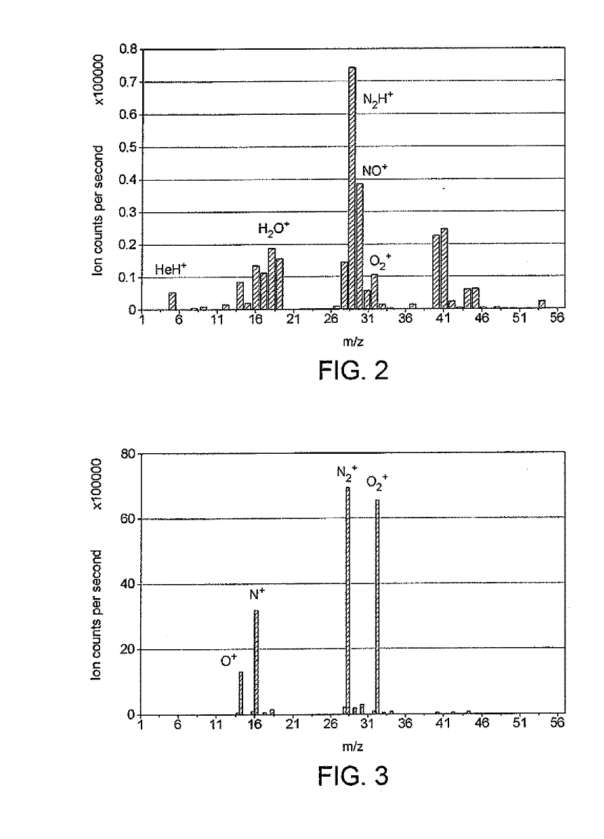

When the apparatus was operated with a closed coupling between the mass spectrometer and the plasma generator and a bias of +15 volts was applied to the sample aperature of the mass spectrometer, a few ions were detected, the most abundant species being N₂H⁺ and NO⁺, but at a level from one to two orders of magnitude less than in subsequent experiments in which the plasma gas was a mixture of helium and an ionisation-sustaining gas. FIG. 2 shows the resulting mass spectrum. The ions detected may reflect trace levels of air and hydrocarbons in the helium, notwithstanding the efforts to minimise the entrapment of adventitious impurities.

The pure helium employed in Example 1 and the other Examples had the following specification:

Purity 99.9999%

O₂<1 ppmv

N₂<1 ppmv

CO₂<1 ppmv

Hydrocarbons <1 ppmv

Water vapour <1 ppmv

Total impurities <1 ppmv.

### Example 2

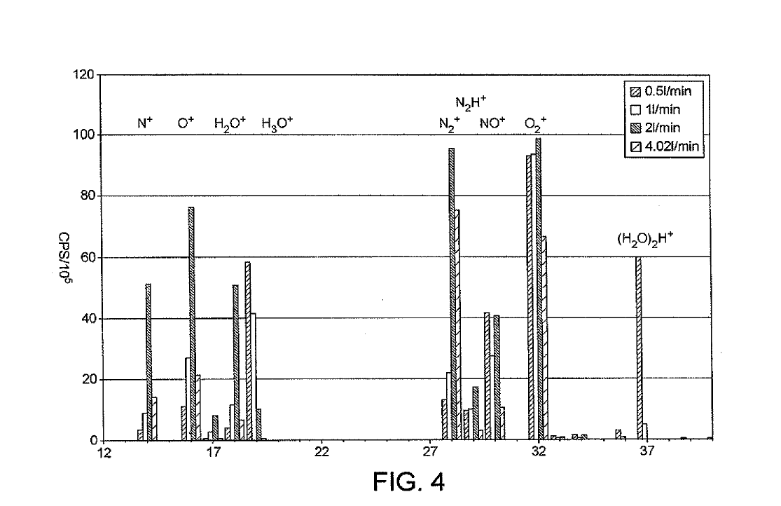

Experiments were now performed substituting mixtures of helium and air for the pure helium fed to the plasma generator. FIG. 3 shows the spectrum for a mixture of 99.5% helium, 0.5% air (by volume) when the flow was 41/min., the current drawn was 0.8 A, and the mass spectrometer was close coupled to the plasma generator. Distinct peaks were observed for atomic weights 14, 16, 28 and 32 corresponding to N⁺, O⁺, N₂⁺ and O₂⁺. The ion counts per second at these peaks were substantially greater than those shown in FIG. 2.

### Example 3

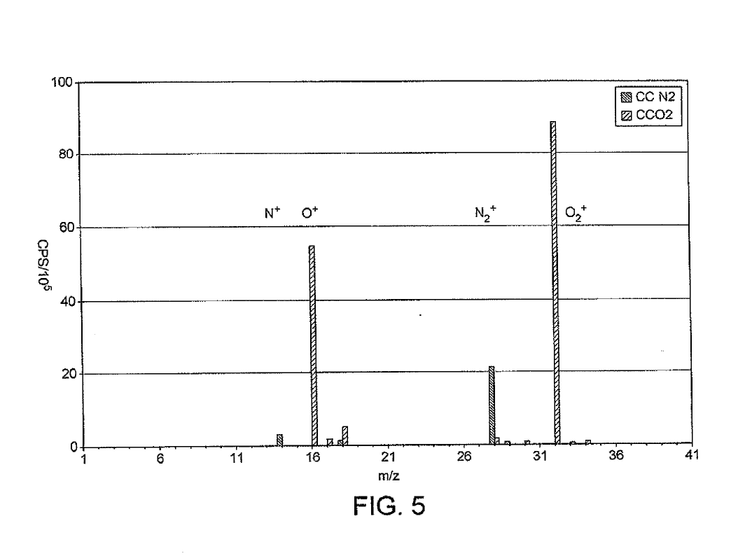

Example 2 was repeated, but with the mass spectrometer making an open coupling with the plasma generator and with a mixture of 99.8% helium, 0.2% air (by volume) substituted or the gas mixture of Example 2. Now, in addition to the peaks attributable to monatomic and diatomic cationic oxygen and nitrogen species, there are peaks attributable to H₃O⁺ and (H₂O)₂H⁺, indicating that water vapour present in ambient air has been entrained by the partially ionised gas at the entrance to the mass spectrometer. Experiments were performed at flow rates of 0.5, 1, 2 and 4.02 litres per minute. FIG. 4 shows the spectrum from each experiment. At each atomic or molecular weight at which a species is detected, the results were presented in the order, left to right, of 0.5, 1, 2 and 4.02 litres per minute. The highest counts of the species N⁺, O⁺, N₂⁺ and O₂⁺ were detected at 2 litres per minute, whereas the highest counts of the species H₃O⁺ and (H₂O)₂H⁺ were detected at 0.5 litres per minute. Higher ion counts per second were detected than with a plasma gas comprising 99.5% by volume of helium and 0.5% by volume of air.

The experiments were repeated but this time with firstly a plasma gas comprising 99.9% by volume of helium and 0.1% by volume of air. The ion counts per second were once again higher.

A final repetition of the experiments using a plasma gas comprising 99.99% helium and 0.01% air produced lower ion counts. These results indicate that the maximum ion count would be obtained with an air concentration in the range of 0.01% and 0.2% by volume.

### Example 4

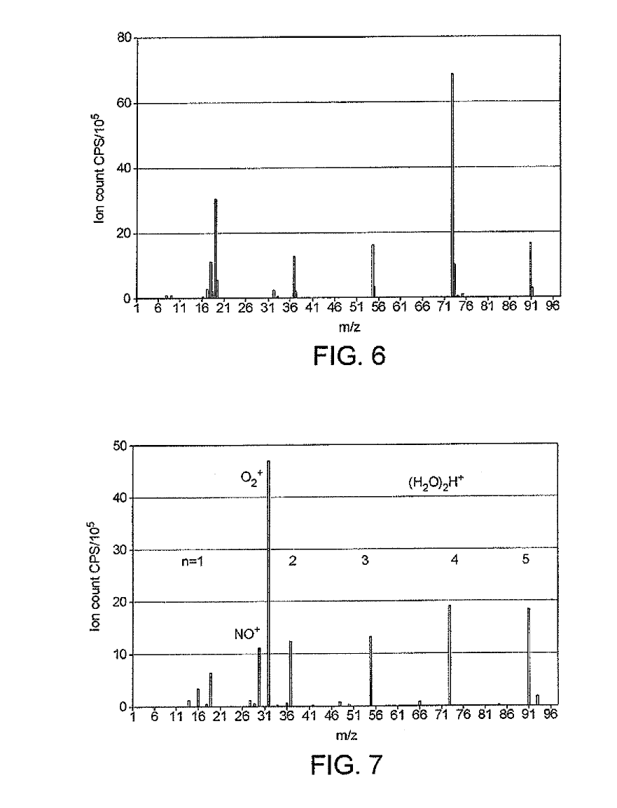

The spectra of (a) a 99.9% by volume and 0.1% by volume nitrogen mixture taken from a plasma generator subject to electrical discharge and (b) a corresponding mixture of helium and nitrogen (the 99.9% by volume; N₂ 0.1% by volume) were taken with the mass spectrometer close coupled to the plasma generator, with a gas flow rate of 1 litre per minute and with a current drawn of 0.8 A. Peaks at atomic/molecular weights of 16 and 32 were obtained for the helium oxygen mixture, the two peaks representing O⁺ and O₂⁺, whereas peaks at 14 and 28 were obtained for the helium-nitrogen mixture, the two peaks representing N⁺ and N₂⁺. These combined spectra are shown in FIG. 5. The ion counts per second are substantially above the minimal ones detected for pure helium (of FIG. 1).

### Example 5

When comparable experiments were performed with a plasma gas mixture of 99.95% He, 0.05% H₂O, the ion content of the plume was too high to record in the mass spectrometer, the peak heights being greater than 10⁷ counts per second.

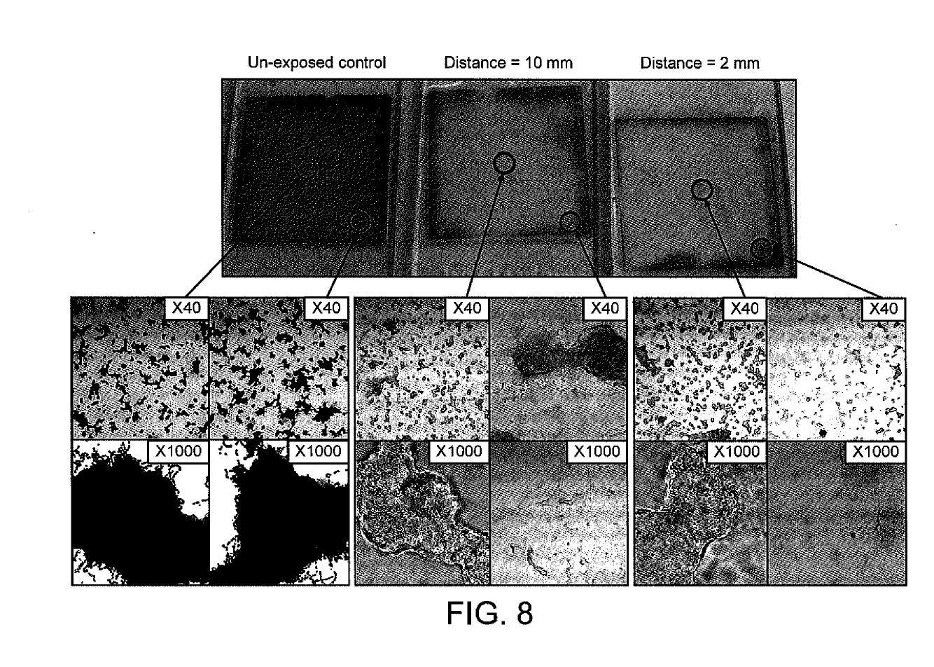

The experiments were therefore repeated with a plasma gas mixture of 99.99% by volume of helium and 0.01% by volume of water vapour, first at a flow rate of 0.5 litres per minute and a current of 0.8 A with the coupling of the mass spectrometer to the plasma generator being open. The spectrum is shown in FIG. 6. Peaks were obtained for (H₂O)ₙH⁺ where n=1, 2, 3, 4 and 5. Peaks were also obtained for O₂⁺ and NO⁺, indicating the very reactive nature of the plume.

A second experiment was performed this time with the coupling of the mass spectrometer to the plasma generator being closed, the flow rate being 2 litres per minute and the current 0.8 A. Now, as shown in FIG. 7, the peaks for (H₂O), H⁺ predominate.

### Example 6

Measurements of ion counts per second were made at a gas flow rate of 2 l/min and the same power setting for mixtures of helium with (a) dry air; (b) nitrogen and (c) oxygen. Measurements were made for mixtures in which the additive was present at a level of 0.1% by volume, and for mixtures in which the additive was present at a level of 0.1% by volume, and for mixtures in which the additive was present at a level of 0.2% by volume. The results are sown in Table 1 below.

Ion count per second/10⁶ for

| Gas mixture | 0.1% by volume of | 0.2% by volume of |
|---|---|---|
| (helium-additive) | additive | additive |
| Helium - dry air | 8.9 | 1.9 |
| Helium - nitrogen | 4.0 | 3.1 |
| Helium - oxygen | 3.3 | 1.8 |

These results indicate that a maximum ion count per second is achieved at an additive gas concentration of up to 0.2% by volume.

The results of Examples 1 to 6 demonstrate that small amounts of deliberately added gaseous or vaporous species such as air, oxygen, nitrogen and water vapour are able substantially to enhance the ionic content of the plume, and hence its reactivity. A more reactive plume will, it is believed, be more effective in whitening or cleaning teeth or in performing other oral treatments. Maximum ion counts per second in the plume are obtained at relatively low concentrations of additive gas. Higher ion counts per second were achieved with water vapour than with the other additives. The ion count per second is related to the ion density in the plume. We believe that an ion count per second of 1×10⁶ is equivalent to an ion density in the plume of approximately 10⁸ ions cm⁻³.

Subsequent emission spectroscopic experiments observing the emission from the plasma generator itself show that a water vapour additive produces higher ion counts than air, oxygen or nitrogen in the actual plasma generator.

### Example 7

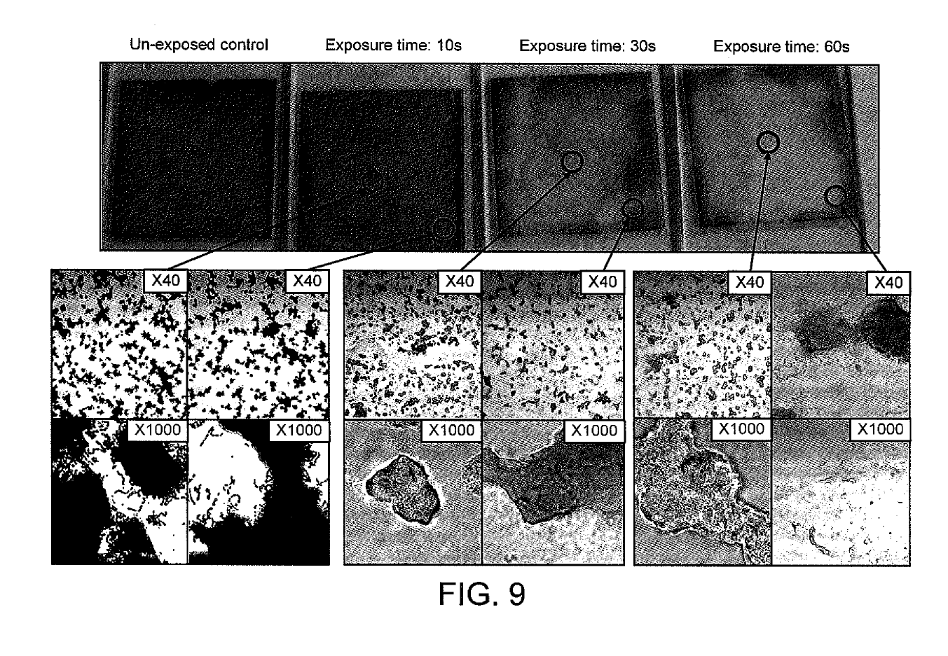

A non-thermal gaseous plasma was created using an apparatus of the kind described with reference to FIG. 1 from the gas stream (flow rate 0.51/min.) formed of helium carrying 500 parts per million of water vapour by volume. The partially-ionised gas exiting the plasma generator was applied as a plume to biofilms of Streptoccoci mutans (NCTC-10919). Experiments were performed for exposure times of 10 s, 30 s and 60 s and at stand-off distances of 2 mm and 10 mm of the biofilm from the tip of the applicator. All these experiments showed destruction of cells. The cells or eradicated cells were readily distinguishable from healthy cells, the former showing only an amorphous cellular debris. Healthy bacteria give a Gram stain that is blue and have well defined shaped. Damaged bacteria give a Gram stain that is pink. The longer the exposure time and the shorter the stand-off distance, the greater the bacteria kill rate. FIGS. 8 and 9 are sets of photographs illustrating the destruction of Streptoccoci mutans bacteria by the plume. Some photographs were taken at ×40 magnification; others at ×1000 magnification.

FIG. 8 shows results for an exposure time of 60 s and stand-off distances of 2 mm and 10 mm.

FIG. 9 shows results for a stand-off distance of 10 mm and for exposure times of 10 s, 30 s and 60 s.

What is claimed is:

1. A method of non-clinical or cosmetic oral treatment, comprising passing a flow of a gas mixture from a pressure vessel containing the gas mixture through a generator of non-thermal gaseous plasma; applying a partially ionising electrical potential to the flow of gas mixture in the plasma generator, and thereby forming a non-thermal gaseous plasma in the gas mixture, and causing the flow of the gas mixture downstream of the plasma generator to perform the non-clinical or cosmetic oral treatment, wherein the gas mixture comprises (a) a noble gas selected from helium and argon and mixtures thereof and (b) an additive gas selected from water vapour, air, oxygen, nitrogen, hydrogen, carbon monoxide, carbon dioxide, nitrous oxide and mixtures of any two or more thereof, and wherein the additive gas forms up to 1% by volume of the gas mixture.

2. A method according to claim 1, wherein the noble gas is helium.

3. A method according to claim 1, wherein the additive gas forms from 0.01% to 0.5% by volume of the gas mixture.

4. A method according to claim 3, wherein the additive gas forms from 0.02% to 0.25% by volume of the gas mixture.

5. A method according to claim 1, wherein the plasma generator has an outlet temperature in the range of 10° C. to 40° C.

6. A method according to claim 1, wherein the plasma generator is operated at a pressure in the range 0.5 to 2 bar.

7. A method according to claim 1, wherein the additive gas is a mixture of (a) oxygen and/or air with (b) hydrogen.

8. A method according to claim 1, wherein the non-clinical or cosmetic oral treatment comprises one or more of:
(a) the removal of stains from teeth;
(b) the whitening of tooth enamel;
(c) the general cleaning of teeth to destroy harmful bacteria;
(d) the interdental cleaning of teeth;
(e) the freshening of breath;
(f) the treatment of halitosis;
(g) the treatment of gingivitis;
(h) the treatment of periodontal disease;
(i) the in situ cleaning of orthodontic braces;
(j) the in situ cleaning of dental implants.

9. A method according to claim 8, wherein the treatment time is from ten seconds to ten minutes.

10. A gas mixture, pre-packaged in a pressure vessel, comprising (a) at least 99% by volume of helium and/or argon and (b) water vapour, wherein the content of water vapour is up to 1% of the total volume of the gas mixture.

11. A gas mixture according to claim 10, wherein the content of water vapour is up to 0.2% of the total volume of the gas mixture.

12. A method of clinical oral treatment, comprising passing a flow of a gas mixture from a pressure vessel containing the gas mixture through a generator of non-thermal gaseous plasma; applying a partially ionising electrical potential to the flow of gas mixture in the plasma generator, and thereby forming a non-thermal gaseous plasma in the gas mixture, and causing the flow of the gas mixture downstream of the plasma generator to perform the clinical oral treatment, wherein the gas mixture comprises (a) a noble gas selected from helium and argon and mixtures thereof and (b) an additive gas selected from water vapour, air, oxygen, nitrogen, hydrogen, carbon monoxide, carbon dioxide, nitrous oxide and nitric oxide and mixtures of any two or more thereof, and wherein the additive gas forms up to 1% by volume of the gas mixture.

13. A method of cleaning in situ an orthodontic brace by directing at the brace a plume of partially-ionised gas.

14. A method according to claim 13, wherein the plume of partially-ionised gas is formed by passing a stream of gas through a plasma-generating chamber of a generator of non-thermal plasma and applying a partially-ionising electrical potential to the stream of gas in the generator.
